(19) United States
(12) Patent Application Publication
(10) Pub. No.: US 2008/0317162 A1
(43) Pub. Date: Dec. 25, 2008

(54) SYSTEM AND METHOD FOR TRANSMITTING/RECEIVING DATA IN COMMUNICATION SYSTEM

(75) Inventors: Kwan-Hee Roh, Hwaseong-si (KR); Min-Hee Cho, Suwon-si (KR); Jae-Hee Cho, Seoul (KR); Jae-Woo So, Bucheon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/141,041

(22) Filed: Jun. 17, 2008

(30) Foreign Application Priority Data
Jun. 19, 2007 (KR) 2007-59887

(51) Int. Cl. H04L 27/00

(52) U.S. Cl. 375/295

(57) ABSTRACT

A system and method for transmitting/receiving data in a communication system is provided. A transmitter is allocated resources using a circuit mode scheme, determines if there is actual data to be transmitted to a receiver, and transmits information representing that there is no actual data to be transmitted using the allocated resources when it is determined that there is no actual data to be transmitted.

### PRIORITY

This application claims the benefit under 35 U.S.C. §119(a) of a Korean patent application filed in the Korean Intellectual Property Office on Jun. 19, 2007 and assigned Serial No. 2007-59887, the entire disclosure of which is hereby incorporated by reference.

### BACKGROUND OF THE INVENTION

1. Field of the Invention

The present invention relates to a system and method for transmitting/receiving data in a communication system. More particularly, the present invention relates to a system and method for transmitting/receiving data during a silence period in a communication system.

2. Description of the Related Art

Research is being conducted on next generation communication systems that provide users with high-speed services having various Qualities of Service (QoSs).

More particularly, in a packet-based communication system, such as an Institute of Electrical and Electronics Engineers (IEEE) 802.16 communication system, limited resources are allocated to users in order to provide a data packet service, and the data packet service is provided to the users using allocated resources. Also, in the packet-based communication system, in order to provide a real-time voice service, such as Voice over Internet Protocol (VoIP) service, resources are not allocated in every frame. Instead, resources are continuously allocated for the real-time voice service during a preset frame period. Accordingly, the packet-based communication system can reduce overhead caused by an allocation of resources for providing the real-time voice service.

However, in the real-time voice service, such as the VoIP service, there is not always data to transmit during a service provision period. That is, when the real-time voice service is provided, data is transmitted only during certain periods during which the user talks, and no data is transmitted during the other periods during which the user does not talk. A period during which no data is transmitted will be referred to as a “silence period.” During such a silence period, it is preferred that a transmitter, e.g. a subscriber station, does not transmit data in order to improve power efficiency and to prevent an increase of unnecessary interference signals in an UpLink (UL). However, since a receiver, e.g. a base station, cannot identify if the subscriber station is in the silence period and if it transmits data, the receiver may operate abnormally.

More particularly, when a transmitter is allocated resources to occupy the resources continuously during a certain period, as described above, although the transmitter does not transmit data during a silence period, the receiver cannot identify if the transmitter transmits data. Accordingly, the receiver determines that the receiver has failed to receive data due to an error in reception despite the transmitter having transmitted the data. As a result, the receiver may perform an abnormal operation, such as requesting the transmitter to retransmit data. That is, since the receiver continuously performs a decoding operation in order to receive data transmitted from the transmitter, and there is no data received by the receiver during the silence period, the receiver faills to decode data, so that the receiver requests the transmitter to retransmit data. Furthermore, when the receiver continuously faills to decode data, the receiver may terminate data transmission of the transmitter, i.e. a service provision for the transmitter, or may release allocated resources by determining that the transmitter is in a state where it cannot receive service.

In order to prevent such an abnormal operation, the transmitter may forcedly transmit data to the receiver during a silent period, even if there is no data to transmit. However, this is a problem in that the power of the transmitter is wasted, and unnecessary interference signals occur in an UL.

### SUMMARY OF THE INVENTION

An aspect of the present invention is to address at least the above-mentioned problems and/or disadvantages and to provide at least the advantages described below. Accordingly, an aspect of the present invention is to provide a system and method for transmitting/receiving data in a communication system.

Another aspect of the present invention is to provide a data transmitting/receiving system and method for a silence period, during which there is no data to be transmitted by a transmitter, in a communication system.

In accordance with an aspect of the present invention, a method for transmitting data by a transmitter in a communication system is provided. The method includes receiving, from a receiver, allocated resources using a circuit mode scheme, determining if there is actual data to be transmitted to the receiver, and transmitting, to the receiver, information which represents that there is no actual data to be transmitted to the receiver by using the allocated resources when there is no actual data to be transmitted to the receiver as a result of the determination.

In accordance with another aspect of the present invention, a method for receiving data by a receiver in a communication system is provided. The method includes receiving data from a transmitter using resources which the receiver has allocated to the transmitter using a circuit mode scheme, determining if the received data comprises information which represents that there is no data to be transmitted from the transmitter, and determining that there is no data to be transmitted from the transmitter when the received data is determined to comprise the information.

In accordance with still another aspect of the present invention, a system for transmitting data is provided. The system includes a transmitter for receiving, from a receiver, allocated resources using a circuit mode scheme, for determining if there is actual data to be transmitted to the receiver, and for transmitting, to the receiver, information, which represents that there is no actual data to be transmitted, to the receiver by using the allocated resources when there is no actual data to be transmitted as a result of the determination, and the receiver.

In accordance with still another aspect of the present invention, a system for receiving data is provided. The system includes a receiver for receiving data from the transmitter using allocated resources using a circuit mode scheme, for determining if the received data comprises data absence information, which represents that there is no data to be transmitted from the transmitter, and for determining that there is no data to be transmitted from the transmitter when the received data is determined to comprise the data absence information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram schematically illustrating the configuration of a communication system according to an exemplary embodiment of the present invention;

FIG. 2 is a flowchart illustrating the operation of a transmitter in a communication system according to an exemplary embodiment of the present invention; and

FIG. 3 is a flowchart schematically illustrating the operation of a receiver in a communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention propose a system and method for transmitting/receiving data in a communication system, for example, in an Institute of Electrical and Electronics Engineers (IEEE) 802.16 communication system, which is a Broadband Wireless Access (BWA) communication system. The data transmitting/receiving system and method according to exemplary embodiments of the present invention may be applied not only to the IEEE 802.16 communication system, but also other communication systems.

Exemplary embodiments of the present invention propose a data transmitting/receiving system and method for allocating limited resources to provide a data packet service to users and for providing the data packet service using the allocated resources in a packet-based communication system, such as the IEEE 802.16 communication system. In this case, according to an exemplary embodiment of the present invention, in order to provide a real-time voice service, such as Voice over Internet Protocol (VoIP) service, in a packet-based communication system, resources are not allocated every frame. Instead, resources are allocated in such a manner (hereinafter, referred to as a “circuit mode scheme”) as to continuously occupy the resources during a preset period, that is, during at least two frames. Accordingly, the packet-based communication system can reduce overhead caused by allocating resources every frame, thereby efficiently providing the real-time voice service. In a state where resources are allocated in the circuit mode scheme, when a transmitter, e.g., a subscriber station, enters a silence period, during which there is no data to transmit, the transmitter notifies a receiver, e.g. a base station, that the transmitter is in the silence period. That is, in the communication system according to an exemplary embodiment of the present invention, the transmitter which is allocated resources using the circuit mode scheme transmits a padding packet to the receiver when there is no data to transmit, thereby notifying the receiver that the transmitter is in the silence period. Accordingly, when the receiver receives the padding packet from the transmitter, the receiver can determine that the transmitter is in a silence period, thereby preventing an abnormal operation from being performed.

Conventionally, a receiver cannot identify if a transmitter transmits data in a silence period. Accordingly, when the receiver does not receive data, the receiver determines that an error occurs in data reception and may perform an abnormal operation, such as requesting the transmitter to retransmit data. However, according to an exemplary embodiment of the present invention, since a transmitter transmits a padding packet to a receiver to notify the receiver that the transmitter is in a silence period, it is possible to prevent an abnormal operation of the receiver. Here, the padding packet acts as a message for the transmitter to notify the receiver that the transmitter is in a silence period, that is, as a message representing that there is no data to be transmitted to the receiver. Therefore, according to an exemplary embodiment of the present invention, instead of actual data, a padding packet is transmitted to the receiver during a silence period so that the advantage of reduced power consumption of the transmitter is achieved, and an interference effect can be minimized.

Also, according to an exemplary embodiment of the present invention, when a transmitter transmits a padding packet to a receiver to notify the receiver that the transmitter is in a silence period, a repetition coding gain of the transmitter increases, thereby minimizing power consumption.

For example, when the transmitter transmits a padding packet by using a modulation and coding scheme of Quadrature Phase Shift Keying (QPSK) with a cording rate of ½, the padding packet is constituted by 48 bits, which include 32 bits for one padding bit stream and 16 bits for a cyclic redundancy check (CRC) code. In this case, a repetition value required for transmitting the padding packet is determined by slots of resources allocated in the circuit mode scheme, for example, by the number of sets of subcarriers which is composed of six 4×3 tiles in the case of Partial Usage of Subchannels (PUSC). In this case, each slot includes 48 data subcarriers, and the repetition value becomes N when the transmitter is allocated N slots of resources.

That is, the transmitter is configured to repeatedly transmit the padding packet N times for each slot when the transmitter transmits the padding packet. In this case, the 48-bit padding packet is modulated and coded using QPSK ½, and is mapped to each slot. When the transmitter transmits a padding packet, transmission power may be expressed as equation 1 below.

P=L+C/N+NI−10 log(R)−Offset_{SS}+Offset_{BS} (1)

In equation 1, “P” represents a transmission power for each subcarrier which includes a transmission antenna gain of a transmitter, “L” represents a UL propagation loss, “C/N” represents a carrier to noise (C/N) ratio which is normalized according to a Forward Error Correction (FEC) rate and a modulation/coding scheme applied upon the transmission of the padding packet, “R” represents a repetition value applied to the FEC, “NI” represents an average reception level of noise and interference signals estimated by a receiver, “Offset_{SS}” represents a power offset controlled by the transmitter, i.e. a subscriber station, and “Offset_{BS}” represents a power offset controlled by the receiver, i.e. a base station. Here, power of the transmitter decreases as the repetition value increases, and the repetition value is proportional to the number of allocated slots. That is, as the number of allocated slots increases, transmission power, i.e. power of the transmitter, for each subcarrier decreases, so that an interference effect also decreases.

Hereinafter, one exemplary embodiment of the present invention will be described in detail with reference to the accompanying drawings.

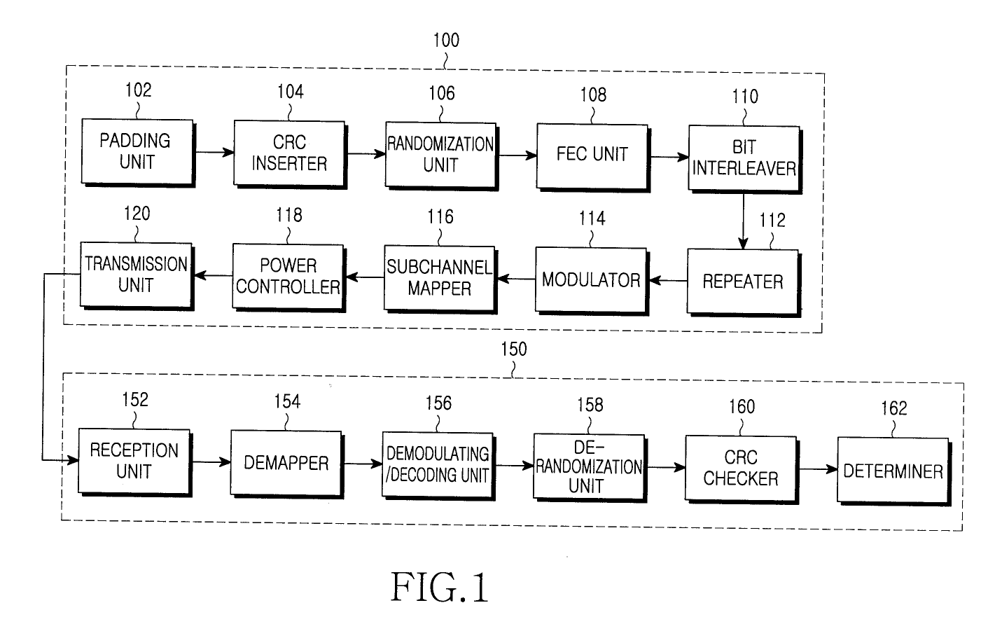

FIG. 1 is a block diagram schematically illustrating the configuration of a communication system according to an exemplary embodiment of the present invention.

The communication system includes a transmitter 100 and a receiver 150. The transmitter 100 includes a padding unit 102, a CRC inserter 104, a randomization unit 106, an FEC unit 108, a bit interleaver 110, a repeater 112, a modulator 114, a subchannel mapper 116, a power controller 118, and a transmission unit 120. The padding unit 102 generates a padding bit stream of a padding packet, e.g. one 32-bit stream as described above, when the transmitter 100 enters the silence period during which there is no data packet to be transmitted to the receiver 150. The CRC inserter 104 adds a CRC code to the generated padding bit stream, for example, adds a 16-bit CRC code to a 32-bit padding bit stream. The randomization unit 106 randomizes an input 48-bit stream which is obtained by adding the CRC code to the generated padding bit stream. The FEC unit 108 performs an FEC operation with respect to an output of the randomization unit 106. The bit interleaver 110 interleaves an output of the FEC unit 108 with a bit. The repeater 112 repeatedly outputs an output of the bit interleaver 110 by a number of times corresponding to a repetition value, which is determined by slots of resources allocated to the transmitter 100 in the circuit mode scheme. The modulator 114 modulates and codes the output of the repeater 112 by using a modulation and coding scheme, e.g. by using QPSK with a coding rate of ½, and the subchannel mapper 116 maps the modulated and coded padding packet into entire subchannels. The power controller 118 determines transmission power, as described above with reference to equation 1, and the transmission unit 120 transmits the padding packet to the receiver 150 with the transmission power determined by the power controller 118.

Meanwhile, the receiver 150 includes a reception unit 152 for receiving a padding packet from the transmitter 100, a demapper 154 for performing a demapping operation corresponding to the mapping operation of the subchannel mapper 116, a demodulating/decoding unit 156 for demodulating and decoding the demapped padding packet, a de-randomization unit 158 for de-randomizing the decoded padding packet, a CRC checker 160 for checking if a CRC code included in the padding packet is detected, and a determiner 162 for determining if the decoding operation has been successfully performed according to a result of the checking by the CRC checker 160 and determining whether to transmit an acknowledgement (ACK) signal or a non-acknowledgement (NACK) signal to the transmitter 100.

When entering the silence period, the transmitter 100 generates one 32-bit stream using a padding bit stream of a padding packet, adds a 16-bit CRC code to the generated 32-bit padding stream, thereby generating a padding packet. Then, with respect to the generated padding packet, the transmitter 100 repeats by the number of slots of resources allocated using the circuit mode scheme, i.e. N times, performs a modulation and coding operations using QPSK with a coding rate of ½, and then maps the modulated and coded padding packet to all of the N slots. Next, the transmitter 100 transmits the mapped padding packet to the receiver 150 with a transmission power determined according to equation 1.

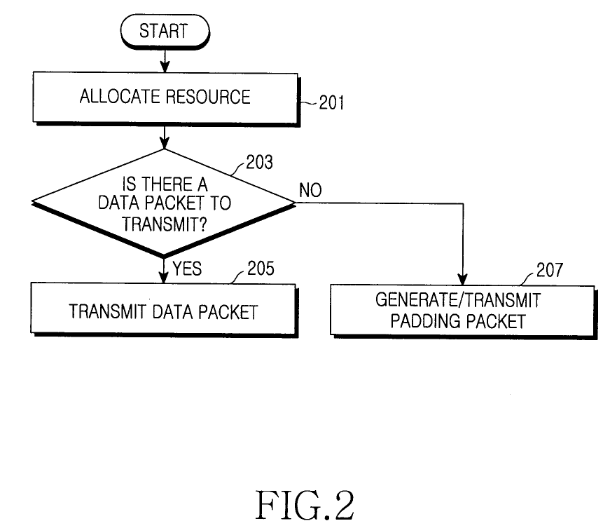

Hereinafter, the operation of a transmitter in a communication system according to an exemplary embodiment of the present invention will be described in detail with reference to FIG. 2.

FIG. 2 is a flowchart illustrating the operation of a transmitter in a communication system according to an exemplary embodiment of the present invention. In step 201, the transmitter is allocated resources using the circuit mode scheme, as described above. Here, for convenience of description, it is assumed that the transmitter is allocated N slots.

Then, in step 203, the transmitter determines if there is a data packet to be transmitted to a receiver using the allocated N slots. When it is determined in step 203 that there is a data packet to be transmitted to the receiver, the transmitter proceeds to step 205, where the transmitter transmits the data packet to be transmitted to the receiver.

In contrast, when it is determined in step 203 that there is no data packet to be transmitted to the receiver, the transmitter proceeds to step 207, where the transmitter generates a padding packet for notifying the receiver that the transmitter is in the silence period in order to prevent an abnormal operation of the receiver. Then, the transmitter transmits the generated padding packet to the receiver. The operation of generating and transmitting the padding packet by the transmitter has been described above, so a detailed description thereof will be omitted here.

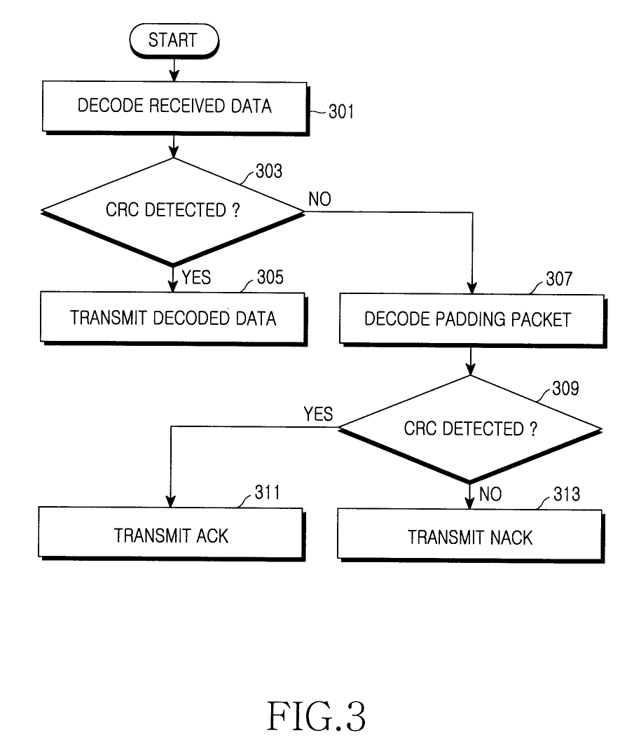

Hereinafter, the operation of a receiver in a communication system according to an exemplary embodiment of the present invention will be described with reference to FIG. 3.

FIG. 3 is a flowchart schematically illustrating the operation of a receiver in a communication system according to an exemplary embodiment of the present invention. The receiver decodes data received from a transmitter in step 301, and determines if a CRC code is detected from the decoded data in step 303. When it is determined in step 303 that a CRC code is detected from the decoded data, the receiver determines that the decoded data corresponds to an actual data packet, i.e. to a data packet received from the transmitter, and proceeds to step 305. In step 305, the receiver transmits the decoded data to an upper layer.

In contrast, when it is determined in step 303 that a CRC code is not detected from the decoded data, the receiver proceeds to step 307, where the receiver decodes a padding packet. Then, the receiver determines if a CRC code is detected from the decoded padding packet in step 309. When it is determined in step 309 that a CRC code is detected from the decoded padding packet, the receiver determines that the data decoded in step 301 corresponds to a padding packet, and proceeds to step 311. In step 311, the receiver transmits an ACK signal to the transmitter. In contrast, when it is determined in step 309 that a CRC code is not detected from the decoded padding packet, the receiver proceeds to step 313, where the receiver transmits a NACK signal to the transmitter.

According to the exemplary embodiments of the present invention as described above, when a transmitter has no data to be transmitted to a receiver in a communication system, the transmitter transmits a padding packet to the receiver, thereby notifying the receiver that the transmitter has no data to transmit. Accordingly, the system and method of the exemplary embodiments of the present invention can prevent the receiver from abnormally operating, and can minimize the power consumption of the transmitter and an interference effect.

While the invention has been shown and described with reference to certain exemplary embodiments thereof, it will be understood by those skilled in the art that various changes in form and details may be made therein without departing from the spirit and scope of the invention as defined by the appended claims and their equivalents. Accordingly, the scope of the invention is not to be limited by the above embodiments but by the claims and the equivalents thereof.

What is claimed is:

1. A method for transmitting data by a transmitter in a communication system, the method comprising:
receiving, from a receiver, allocated resources using a circuit mode scheme;
determining if there is actual data to be transmitted to the receiver; and
transmitting, to the receiver, information which represents that there is no actual data to be transmitted to the receiver by using the allocated resources when there is no actual data to be transmitted to the receiver as a result of the determination.

2. The method as claimed in claim 1, wherein the information comprises a padding packet, and the padding packet comprises a padding bit stream and a cyclic redundancy check (CRC) code.

3. The method as claimed in claim 1, wherein the transmitting of the information comprises:
repeating the information a number of times equal to the number of slots included in the allocated resources thereby generating a repeated information; and
transmitting, to the receiver, the repeated information by using the slots.

4. The method as claimed in claim 3, wherein the transmitting of the information comprises using a transmission power value determined according to the transmission of the repeated information.

5. A method for receiving data by a receiver in a communication system, the method comprising:
receiving data from a transmitter using resources which the receiver has allocated to the transmitter using a circuit mode scheme;
determining if the received data comprises information which represents that there is no data to be transmitted from the transmitter; and
determining that there is no data to be transmitted from the transmitter when the received data is determined to comprise the information.

6. The method as claimed in claim 5, wherein the determining if the received data comprises information comprises determining if a cyclic redundancy check (CRC) code is detected from the received data.

7. The method as claimed in claim 5, wherein the information comprises a padding packet, and the padding packet comprises a padding bit stream and a cyclic redundancy check (CRC) code.

8. The method as claimed in claim 5, wherein the determining that there is no data to be transmitted from the transmitter comprises:
determining if a cyclic redundancy check (CRC) code is detected from the information; and
transmitting at least one of acknowledgement (ACK) and non-acknowledgement (NACK) signals to the transmitter according to a result of the determination if the CRC code is detected from the information.

9. A system for transmitting data, the system comprising:
a transmitter for receiving, from a receiver, allocated resources using a circuit mode scheme, for determining if there is actual data to be transmitted to the receiver, and for transmitting, to the receiver, information, which represents that there is no actual data to be transmitted to the receiver by using the allocated resources when there is no actual data to be transmitted as a result of the determination;
and the receiver.

10. The system as claimed in claim 9, wherein the information comprises a padding packet, and the padding packet comprises a padding bit stream and a cyclic redundancy check (CRC) code.

11. The system as claimed in claim 9, wherein the transmitter repeats the information a number of times equal to the number of slots included in the allocated resources thereby generating a repeated information, and transmits, to the receiver, the repeated information by using the slots.

12. The system as claimed in claim 11, wherein when the transmitter transmits the information, the transmitter uses a transmission power value determined according to the transmission of the repeated information.

13. A system for receiving data, the system comprising:
a transmitter; and
a receiver for receiving data from the transmitter using resources which the receiver has allocated to the transmitter using a circuit mode scheme, determining if the received data comprises information, which represents that there is no data to be transmitted from the transmitter, and determining that there is no data to be transmitted from the transmitter when the received data is determined to comprise the information.

14. The system as claimed in claim 13, wherein the receiver determines if the received data comprises the data by determining if a cyclic redundancy check (CRC) code is detected in the received data.

15. The system as claimed in claim 13, wherein the data absence information comprises a padding packet, and the padding packet comprises a padding bit stream and a cyclic redundancy check (CRC) code.

16. The system as claimed in claim 13, wherein the receiver transmits at least one of acknowledgement (ACK) and non-acknowledgement (NACK) signals to the transmitter according to a result of the determination if a cyclic redundancy check (CRC) code is detected in the information.
